(19) United States
(12) Patent Application Publication
(10) Pub. No.: US 2025/0022030 A1
(43) Pub. Date: Jan. 16, 2025

(54) GENERATION AND APPLICATION OF EMBEDDINGS FOR LODGING ITEMS

(71) Applicant: Expedia, Inc., Seattle, WA (US)

(72) Inventor: Ioannis Partalas, Hautemorges (CH)

(21) Appl. No.: 18/221,730

(22) Filed: Jul. 13, 2023

(51) Int. Cl. G06Q 30/0601; G06F 40/279; G06Q 30/0282

(52) U.S. Cl. CPC G06Q 30/0627; G06F 40/279; G06Q 30/0282; G06Q 30/0631

(57) ABSTRACT

Systems and methods of generating a set of vectors or embeddings that represent concepts and/or lodging items identified from review data (e.g., user reviews). Concepts and associated sentiments are identified within each review of the review data to generate labeled review data that is provided to a machine learning model that is programmed to iterate through each mention of each concept in each review of the labeled review data to update one or more embeddings corresponding to concepts and/or lodging items mentioned in each of the reviews. A multi-dimensional embedding space comprising embeddings or vectors for concepts and/or lodging items is then queried to provide results (e.g., to a user device).

### BACKGROUND

Computing devices, along with computing networks, have become ubiquitous and play an integral role in how individuals gather information and complete purchases. For example, a user, via their personal computing device, can interact with network-based information services to search for, review, and share details regarding items the user is interested in. This also extends to purchasing products a user may want from network-based retailers. The versatility of these network-based services allows users to perform these tasks from the comfort of their own homes or offices, and at their own pace and convenience.

Due to the breadth of information available online, network-based services provide users with the ability to search for specific information by submitting structured or unstructured queries. However, one limitation of these queries is their inability to reliably generate relevant results, often because they fail to fully comprehend the user's intent. For instance, a user may search for a “hotels near beaches.” In this scenario, the network-based service may not be able to infer from the text of the query whether the user is interested in all hotels near beaches, or, if the user has a preference for certain types of beaches. Moreover, the network-based service may struggle with understanding the contextual definition of a “beach” from the user's perspective. Thus, simply executing the query as-is could be highly likely to produce a significant amount of information that is irrelevant to the user, resulting in a decrease in user satisfaction with the network-based service and consequently a decrease in the user's use of the network-based service.

### BRIEF DESCRIPTION OF DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a schematic block diagram of an example network environment in which a network-based travel service may operate, according to various aspects of the present disclosure;

FIG. 2 is a block diagram of example components of an embedding generation system, according to various aspects of the present disclosure;

FIG. 3 is an illustrative diagram representing an example embedding space, according to various aspects of the present disclosure;

FIG. 4 is a flow diagram for creating or updating vectors for an embedding space, according to various aspects of the present disclosure;

FIG. 5 is an illustrative block diagram showing an example of generating vectors for lodging items and concept information, according to various aspects of the present disclosure;

FIG. 6 is a flow diagram showing an example of processing user submitted search queries, according to various aspects of the present disclosure; and

FIG. 7 is a block diagram illustrating components of an example computing system that can be used to implement the various systems and methods described herein.

### DETAILED DESCRIPTION

Aspects of the present disclosure relate to generating and utilizing vectors (e.g., within an embedding space) such that correlative information between lodging items (e.g., hotels, bed and breakfasts, or the like) and various concepts (e.g., related to travel) is retained, with the aim of facilitating improved performance of travel-related systems, such as travel-related search engines.

As used herein, and in some aspects, an embedding space is an n-dimensional coordinate system, where n is the number of dimensions in the embedding space. A machine learning algorithm, for example, may generally treat each of the n dimensions as a distinct “feature”—a value to be compared to other distinct values for correlation indicative of a given output. As the number of features of a machine learning model (e.g., neural network, model, algorithm, learning function, or the like) increases, so does the complexity of the machine learning model.

Embedding spaces enable specification of machine-readable representations (embeddings) as vectors, where each vector represents something (e.g., an idea, an emotion, an object, etc.) in the real world. Each point (e.g., represented by a vector) within the embedding space has an n-dimensional location with n-dimensional coordinates where a distance between a set of two points or vectors signifies a relationship between the two points. For example, the distance can be measured using similarity measures such as one or more of: inner product, cosine similarity, dot product, Euclidean distance, or other similar functions. Locations or coordinates in the embedding space can represent correlations in a large variety of abstract dimensions. However, where correlations might be relatively easy for a human to identify, correlations would be difficult to represent or communicate to a machine. For example, “boat” and “ship” are easily seen by a human as strongly correlated, but this correlation is difficult to represent to a machine (e.g., a computer) without a mathematical representation of the concepts. So, generating a first vector to represent a concept “boat” and a second vector to represent a concept “ship”, and assigning the first and second vectors n-dimensional locations that are close in an embedding space, allows their strong relationship/correlation to be represented to a machine. So, in this example, the closer two vectors are in the n-dimensional space, the more correlated they are, and the farther away two vectors are from each other in the n-dimensional space, the less correlated they are. Additionally, as correlations between concepts are more complex, and as dimensions of comparison are increased, a human will not be able to identify or articulate any relationship and having a machine learning algorithm, examples of which are described further herein, to compare such concepts becomes essential.

In some aspects, vectors are typically generated using embedding, a process in machine learning. For example, embedding involves training a machine learning model (e.g., an artificial neural network, learning function, other deep learning model, or the like) to encode defining characteristics of input data into vectors with locations in the embedding space. In some aspects, an embedding system may use user review data or review data (e.g., corresponding to lodging items, or the like) to generate a first set of vectors within an embedding space representing lodging items (also referred to as “lodging item vectors”) and a second set of vectors representing concepts or concept information (also referred to herein as “concept vectors”). Concepts (e.g., as represented by concept vectors) may be significant to a user and may include concepts such as “swimming” or “pool.” Concept information, for example, can include the concept itself as well as additional information relating to the associated concept included in the review data, such as statistics relating to the frequency of appearance of the concept in the review data, and statistics for the frequency of appearance relating to individual lodging items being reviewed.

User review data or review data (e.g., hotel reviews, and the like) captures human-level knowledge of relationships between lodging items and concepts. Concept information may be included in the review data as part of individual reviews. For example, a user may describe a lodging item in a review in terms of one or more concepts. Additionally, sentiment information, similarly expressed in individual reviews of the review data can shed further light on the relationship between any particular concept and at least one lodging item. For example, given a user review of: “Hotel 1 has a good pool and a bad beach,” a review analysis system may extract “Hotel 1” as a lodging item, “beach” and “pool” as concepts, and “good” and “bad” as sentiments. The phrase “Hotel 1 has a good pool . . . ,” may attach a positive connotation or sentiment to the concept “pool” as it relates to hotel 1, and in contrast, the phrase “Hotel 1 has . . . a bad beach,” may attach a negative connotation or sentiment to the concept beach as it relates to hotel 1. In some aspects, identified positive and negative connotations may be reflected in input data used to train a machine learning model to generate vectors. For example, the connotations may be used to label the input data. Once the connotations or sentiments are processed, for example, a concept vector representing “pool” may be adjusted (e.g., by adjusting its corresponding coordinates) to be closer in an embedding space to a lodging item vector representing “Hotel 1” (due to positive connotation or sentiment between the two as expressed in a review), and a concept vector representing “beach” may be adjusted to be farther away in the embedding space from the lodging item vector representing “Hotel 1” (due to negative connotation or sentiment between the two as expressed in a review).

Different reviews may result in different adjustments (e.g., or even no adjustments) to coordinates corresponding to concept vectors and/or lodging item vectors, or addition of new lodging item vectors and/or concept vectors, in an embedding space. For example, by repeating the described adjustment process of updating or adjusting vectors based on a large number of reviews, the machine learning model may generate an embedding space with vectors representing a wide variety of concepts and lodging items. In some aspects, the generated embedding space may also signify or represent relationships other than those explicitly captured in reviews. For example, because there is a shared space for all identified concepts and all identified lodging items (e.g., as referenced in user reviews, or captured through other data collection methods), the adjustment process may cause a first lodging item vector and a first concept vector to move closer together even if no user review for a first lodging item corresponding to the first lodging item vector discusses a first concept corresponding to the first concept vector (e.g., because distinct movement operations for the two, based on data that relates to each item individually, cause the two to move to a similar location in the embedding space). Similarly, related concepts can move closer together (e.g., due to their individual movements) even if they are not mentioned in the same user reviews.

Once an embedding space is generated, a machine can leverage the representation of that knowledge to improve performance, such as by providing more relevant search results (e.g., in response to a user query). According to some aspects, to respond to a user query, a search system may first identify one or more concepts within the query. The search system may then locate these concept(s) in the embedding space and extract a list of lodging items that are near the concept(s) in the embedding space (e.g., based on a distance in the space as determined by each item's coordinates in the space). For example, the distance can be measured using similarity measures such as one or more of: inner product, cosine similarity, dot product, Euclidean distance, or other similar functions. The identified lodging items can then be returned as search results in response to the user query. As an example, and with reference to the example described above, a user query of “hotels with pools” may return hotel 1 based on the machine's understanding that hotel 1 is positively associated with the concept of a pool (e.g., where a lodging item vector corresponding to hotel 1 has a location nearby the concept vector corresponding to “pool” in an embedding space).

Generation of an embedding space using the described systems and methods reflects an improvement to network-based service systems, such as travel-related systems or travel-related search engines. This is because the described systems and methods allows relationship information among concepts and lodging items to be learned directly from users (e.g., through review data). As discussed above, for example, each review in the review data may include one or more of: lodging item(s), concept(s), and sentiment(s). Iterating through the review data to generate an embedding space enables development of an awareness of how various concepts relate to lodging items, according to users. This awareness can be used to improve travel-related services, such as travel related searches since over large volumes of data, user opinions can be reliable predictors for how users will react in the future as well.

The above-described aspects and other aspects of the disclosure will now be described with regard to certain examples, embodiments, and aspects, which are intended to illustrate but not limit the disclosure. Although the examples, embodiments, and aspects described herein will focus on, for the purpose of illustration, specific calculations and algorithms, one of skill in the art will appreciate the examples are illustrative only and are not intended to be limiting.

I. Example Network and/or Operating Environment

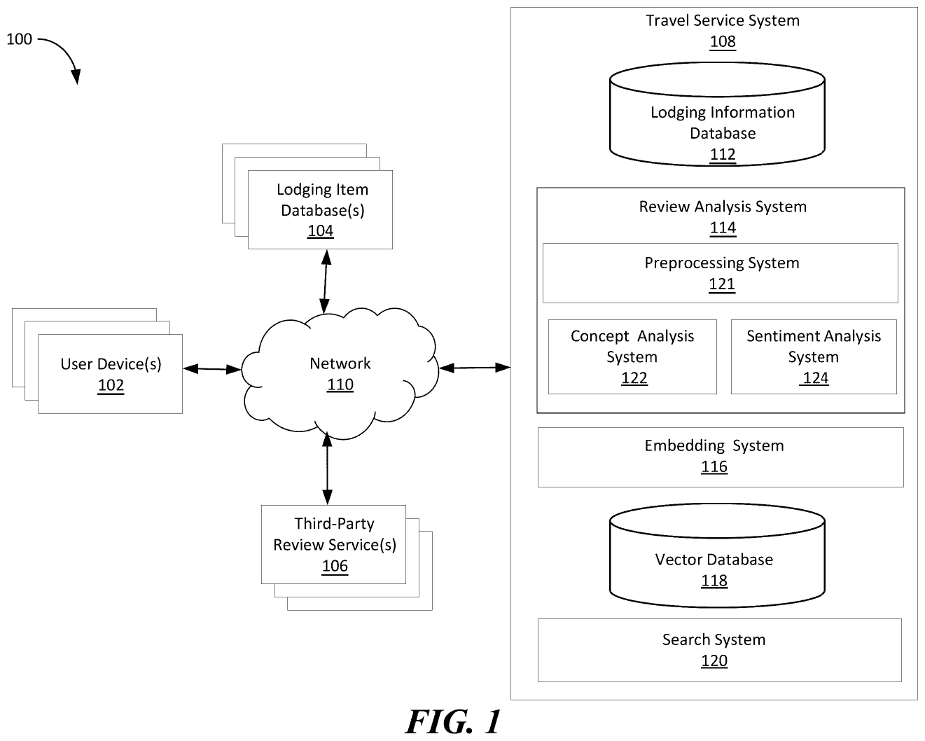

FIG. 1 is a schematic block diagram of an example network environment 100 in which a network-based travel service may operate, according to various aspects of the present disclosure. In some implementations, the environment 100 may be configured to receive or accept queries submitted by users, and subsequently provision results tailored to each user's intent determined from the respective query. The network environment 100 includes user device(s) 102, lodging item database(s) 104, third-party review service(s) 106, and a travel service system 108, all in communication with each other through network 110. The travel service system 108 can include various hardware components and software components and can provide various functionality as described further herein.

In various aspects, communications among the various components of the example network environment 100 may be accomplished via any suitable device, systems, methods, and/or the like. For example, the travel service system 108 may communicate with the user device(s) 102, the lodging item database(s) 104, and/or the third-party review service(s) 106 via any combination of the network 110 or any other wired or wireless communications networks, method (e.g., Bluetooth, WiFi, infrared, cellular, and/or the like), and/or any combination of the foregoing or the like. As further described below, network 110 may comprise, for example, one or more internal or external networks, the Internet, and/or the like.

Further details and examples regarding the implementations, operation, and functionality of the various components of the travel service system 108 and the example environment 100 are described herein in reference to various figures.

a. Network

The network 110 can include any appropriate network, including wired network, wireless network, or combination thereof. For example, network 110 may be a personal area network, local area network, wide area network, cable network, satellite network, cellular network, or any other such network or combination thereof. As a further example, the network 110 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 110 may be a private or semi-private network, such as a corporate or university intranet. The network 110 may include one or more wireless networks, such as a Global System for Mobile Communications (GSM) network, a Code Division Multiple Access (CDMA) network, a Long-Term Evolution (LTE) network, C-band, mmWave, sub-6 GHz, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 110 can represent a network that may be local to a particular organization, e.g., a private or semi-private network, such as a corporate or university intranet. In some implementations, devices (e.g., travel service system 108, user devices, and/or the like) may communicate via the network 110 without traversing an external network, such as the Internet. In some implementations, devices connected via the network 110 may be walled off from accessing the Internet. As an example, the network 110 may not be connected to the Internet. Accordingly, e.g., the user device(s) 102 may communicate with the travel service system 108 directly (via wired or wireless communications) or via the network 110, without using the Internet. Thus, even if the network 110 or the Internet is down, the travel service system 108 may continue to communicate and function via direct communications (and/or via the network 110).

b. Example User Devices

User device(s) 102 illustratively correspond to any computing device that provides a means for a user or admin to interact with another device (e.g., travel service system 108, third-party review service(s) 106, lodging item database(s) 104, or the like). For example, a user, with user device(s) 102, may browse for lodging, reserve or book lodging items, and/or write reviews relating to lodging items. Of course, other activities may also be performed by a user with a user device(s) 102. User devices 102 may include user interfaces or dashboards that connect a user with a machine, system, or device. In various implementations, user device(s) 102 include computer devices with a display and a mechanism for user input (e.g., mouse, keyboard, voice recognition, touch screen, and/or the like). In various implementations, the user device(s) 102 include desktops, tablets, e-readers, servers, wearable device, laptops, smartphones, computers, gaming consoles, and the like. In some implementations, user device(s) 102 can access a cloud provider network via the network 110 to view or manage their data and computing resources, as well as to use websites and/or applications hosted by the cloud provider network. Elements of the cloud provider network may also act as clients to other elements of that network. Thus, user device(s) 102 can generally refer to any device accessing a network-accessible service as a client of that service.

c. Lodging Item Databases

Lodging item database(s) 104 illustratively includes lodging item attributes (e.g., physical address, information regarding amenities, hours of operation, or the like). In some implementations, lodging item database(s) 104 may be accessible through one or more online services (e.g., website(s), application(s), API(s), or the like) that connect lodging items (e.g., hotels, bed and breakfasts, etc.) with users, such as via network 110. For example, in some implementations, there may be a mobile application, connected to a first lodging item database (e.g., 104), operated by managers/owners of a first lodging item to provide potential customers with lodging item attributes for that individual lodging item. The mobile application may allow users to submit reviews (e.g., review data) for the first lodging item, which may then be stored in the first lodging item database. Then, the review data associated with the first lodging item may be accessed by travel service system 108 (e.g., through network 110).

d. Third-Party Review Services

Third-party review service(s) 106 provide review data to travel service system 108. For example, in some implementations, a first third-party review service may operate a lodging item database(s) 104. Additionally, or alternatively, a third-party review service may aggregate review data from one or more lodging item database(s) 104 and provide the aggregated review data to the travel service system 108.

In some implementations, a second third-party review service (e.g., 106) may provide an online platform for users to provide, write, or submit reviews about one or more lodging items. For example, in some implementations, a user may provide, write, or submit a first review data for “Hotel A,” “Hotel B,” and “Hotel C.” The first review data may then be provided to travel service system 108 (e.g., through network 110). For example, a first travel service (e.g., travel service system 108) may pull, receive, or extract review data from a plurality of databases (e.g., lodging item database(s) 104) belonging to, or operated by, at least one third-party.

e. Travel Service System

Within environment 100, travel service system 108 operates to generate embeddings for (1) lodging items, and (2) concepts, within an embedding space. The travel service system 108 may include one or more of the following subcomponents: a review analysis system 114, a lodging information database 112, an embedding system 116, a vector database 118, and a search system 120. Each of the travel service system 108 and/or one or more of the corresponding subcomponents described can also be implemented as a distinct system (e.g., on one or more computing systems with one or more processors and one or more memories) or as part of other systems that implement one or more of the subcomponents (e.g., and potentially other subcomponents or systems not described herein).

In some implementations, the travel service system 108 operates or hosts a mobile application and/or website that sells or markets lodging items and/or related travel items, services, or activities. In some implementations, users may provide reviews of lodging items (e.g., review data) to the travel service system 108 (e.g., by submitting them to the travel website). In some implementations, review data can be accessed, retrieved, purchased, or the like by the travel service system 108 (e.g., from the lodging item database(s) 104, third-party review service(s) 106, or other similar entities or databases). In some embodiments, the mobile application and/or website may be included in the search system 120. In some embodiments, the travel service system 108 may have more than one website, database, or the like. Additionally, in some implementations, subcomponents of travel service system 108 can communicate through network 110 and/or other networks, such as a local network.

In some implementations, the travel service system 108 can be implemented on a cloud provider network (e.g., that can be accessed by user device(s) 102 over a network 110). A cloud provider network (sometimes referred to simply as a “cloud”), refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

The cloud provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services). The resources required to support the operations of such services (e.g., compute and storage resources) may be provisioned in an account associated with the cloud provider, in contrast to resources requested by users of the cloud provider network, which may be provisioned in user accounts. The cloud provider network can include sets of host computing devices, where each set can represent a logical group of devices, such as a physical “rack” of devices. Each computing device can support one or more hosted machine instances that may be virtual machine instances, representing virtualized hardware supporting, e.g., an operating system and applications. Hosted machine instances may further represent “bare metal” instances, whereby a portion of the computing resources of the computing device directly support (without virtualization) the machine instance. In some cases, a machine instance may be created and maintained on behalf of a client. For example, a client may utilize a client computing device to request creation of a machine instance executing client-defined software. In other cases, machine instances may implement functionality of the cloud provider network itself. For example, machine instances may correspond to block storage servers, object storage servers, or compute servers that in term provide block storage, object storage, or compute, respectively, to client computing devices. While block storage, object storage, and compute are example services, machine instances can additionally or alternatively represent domain name services (“DNS”) servers, relational database servers, servers providing serverless computing services, and other server services for supporting on-demand cloud computing platforms. Each host computing device includes hardware computer memory and/or processors, an operating system that provides executable program instructions for the general administration and operation of that server, and a computer-readable medium storing instructions that, when executed by a processor of the server, allow the server to perform its intended functions. Furthermore, the cloud provider network may include other computing devices facilitating operation of the host computing devices, such as data stores to store account information, computing devices to implement logging, monitoring, and billing services, etc.

In some implementations, the cloud provider network can provide on-demand, scalable computing platforms to users through the network 110, for example allowing users to have at their disposal scalable “virtual computing devices” via their use instances or services provided by such instances. These virtual computing devices have attributes of a personal computing device including hardware (various types of processors, local memory, random access memory (“RAM”), hard-disk and/or solid-state drive (“SSD”) storage), a choice of operating systems, networking capabilities, and pre-loaded application software. Each virtual computing device may also virtualize its console input and output (“I/O”) (e.g., keyboard, display, and mouse). This virtualization allows users to connect to their virtual computing device using a computer application such as a browser, application programming interface, software development kit, or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires. Users can choose to deploy their virtual computing systems to provide network-based services for their own use and/or for use by their customers or clients.

In some implementations, the cloud provider network 120 can be formed as a number of regions, where a region is a separate geographical area in which the cloud provider clusters data centers. As such, the cloud provider network may be considered as a distributed computing system. Each region can include two or more availability zones connected to one another via a private high-speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs are the primary backbone locations linking customers to the cloud provider network, and may be collocated at other network provider facilities (e.g., Internet service providers, telecommunications providers) and securely connected (e.g., via a VPN or direct connection) to the availability zones. Each region can operate two or more TCs for redundancy. Regions are connected to a global network which includes private networking infrastructure (e.g., fiber connections controlled by the cloud provider) connecting each region to at least one other region. The cloud provider network may deliver content from points of presence outside of, but networked with, these regions by way of edge locations, regional edge cache servers. This compartmentalization and geographic distribution of computing hardware enables the cloud provider network to provide low-latency resource access to customers on a global scale with a high degree of fault tolerance and stability. In some implementations, the cloud provider network can include one or more cellular networks managed and provided by the cloud provider.

i. Lodging Information Database

Travel service system 108 is configured to receive, retrieve, pull, extract, or otherwise access information, such as user reviews (e.g., review data) and/or data corresponding to lodging item(s) (e.g., attributes) through network 110. This information, for example, may be stored in a lodging information database 112. Travel service system 108 may also collect, receive, and/or store information, such as user review(s) and/or data corresponding to lodging item(s), through internal services without requiring receipt of such information through outside entities including, but not limited to, user devices, lodging item databases, or.

Lodging item attributes may include any attributes relating to a lodging item including, but not limited to, the location of the lodging item and information relating to amenities. Amenities may include pools, fitness centers, nearby attractions, and the like. This information may be stored in a database, such as lodging information database 112.

In some implementations, review data (e.g., accessed by travel service system 108) may also be stored in lodging information database 112. Also, in some implementations, a review analysis system 114 may access this review data to generate labeled review data including at least identifiers relating to at least one concept and/or at least one sentiment. In some implementations, labeled review data may be stored in lodging information database 112. In some implementations, the embedding system 116 may receive, retrieve, pull, extract, or otherwise access the review data and/or labeled review data within the lodging information database 112. For example, embedding system 116 may receive, retrieve, pull, extract, or otherwise access data from lodging information database 112 in generating vectors or embeddings for lodging items and/or concepts.

ii. Review Analysis System

Review analysis system 114 processes review data. Review analysis system 114 may be configured to execute instructions to extract concepts and sentiments from review data.

In some implementations, review data may be provided from lodging item database(s) 104, user device(s) 102, third-party review service(s) 106, and/or similar sources. In some implementations, review data may include review identifiers for each individual review. For example, the review identifiers may be included in the review data at the time of receipt by the travel service system 108. Additionally, or alternatively, review identifiers may be added to the data after receipt by the travel service system 108.

In some implementations, review data may include reviews in one or more different languages. The review analysis system 114 can be configured, in some implementations, to analyze review data in any language to understand meaning of various terms so that any resulting vectors generated (e.g., for lodging items or concept) can be based on review data in any language. Such a configuration may be beneficial since lodging items may be available world-wide and review data may include reviews in languages associated with the location in which a lodging item is physically located. Furthermore, analyzing different languages to extract concepts is different than translating reviews and then processing because there may be nuances and meanings that translation cannot capture. For example, there may be regional euphemisms, expressions, or other meanings that cannot translate into English. Furthermore, upon querying the vectors for lodging item recommendations, although an embedding space may be generated based on review data in one language, the results can be presented in the language corresponding to the query so that a user running the query wouldn't know that the embedding space is basing its recommendation on review data in another/different language. This is advantageous for users of a travel service system 108 since the user themselves may not be able to read or understand reviews in a second language, so being able to reliably use the travel service system 108 to extract information from such reviews would be helpful in allowing the user to select the most appropriate lodging item for them based on their desires/intent. In some implementations, different embedding spaces can exist for different languages. In some implementations, a travel service system 108 can reference one or more embedding spaces (e.g., each created based on user reviews for a different language) and return results based some comparison between the one or more embedding spaces (e.g., weighted by how much review data is used for each embedding space, ranked by how often a lodging item is returned by a query from the most embedding spaces, etc.).

a. Preprocessing System

Review analysis system 114 illustratively includes a preprocessing system 121. In some implementations, preprocessing system 121 adds review identifiers to the review data for each identified individual review. In some implementations, review identifiers may already be present in the review data.

In some implementations, the preprocessing system 121 uses a machine learning algorithm (e.g., a neural network) to identify features of individual reviews (e.g., as stored in review data) to remove, filter, or update. In some implementations, preprocessing system 121 may implement at least one filtering step to remove undesired language, such as foul language or other preconfigured information by a user or administrator of the travel provider 108. For example, there may be profanity or undesirable content in the user review that should be removed prior to analysis (e.g., by the concept analysis system 122 and/or the sentiment analysis system 124). In some implementations, undesired language may include duplicate data or data not relating to the lodging item being analyzed. The presence of undesired language in a review may result in the removal of that review from the review data, or removal or replacement of specific language from the review. For example, preprocessing system 121 may identify undesired language in the review data and subsequently replace the identified undesired language with synonym(s), alternative text that include the same or a similar meaning, or other replacement content. Identification and removal of individual reviews may be based in part on review identifiers present where the undesired language is present. Additionally, or alternatively, preprocessing system 121 may remove undesired language from the review data without removing the reviews in which it is found. Also, for example, there may be typographical errors that are identified that can be updated or corrected prior to analysis. In some implementations, preprocessing system 121 may also remove an individual review entirely (e.g., because it is a duplicate, or for other reasons determined by the machine learning algorithm).

b. Concept Analysis System

Review analysis system 114 illustratively extracts concepts from review data. In some implementations, a machine learning algorithm (e.g., neural networks) may be trained to detect features (e.g., frequency, placement, etc.) within the review data and identify concepts. For example, the review analysis system 114, by using a concept analysis system 122, generates and/or analyzes statistical information associated with at least a portion of the review data. The statistical information reveals concept information within the review data, and the review analysis system 114 uses the statistical information reveals to identify concepts from the review data. Statistical information, for example, may include one or more of: frequency of appearance of terms within the review data, placement of the term within the review, or other metrics relevant to the analysis.

In some implementations, concepts may fall within broad categories including, but are not limited to: lodging attributes, available amenities for lodging items, descriptions of lodging items, attractions nearby each of the lodging items, and activities available to patrons of each of the lodging items. For example, specific concepts may include, but are not limited to: pool, fitness center, 1920s theme, fishing theme, haunted, luxury, budget, mountains, rivers, lakes, beaches, hiking, swimming, skiing, fishing, etc. In some implementations, the concept analysis system 122 can add at least one concept identifier to the review data that is analyzed by concept analysis system 122. For example, the concept identifiers may be, but are not limited to: a numeric value, an alphanumeric value, or a text string. In some implementations, concept analysis system 122 may add concept identifier to the review data (e.g., to label where the concept appears in the review data).

In some implementations, the concept analysis system 122 may first identify at least one concept within the review data. Then, the concept analysis system 122 generates a concept identifier for each identified concept. Then, the concept analysis system 122 iterates through the review data and adds in concept identifiers where the corresponding concept is found. For example, given a first concept identifier representing a first concept, concept analysis system 122 may iterate through each review of the review data to identify concepts within the review to add the first concept identifier to reviews in which the first concept is identified/located. In some implementations, generation and inclusion of a concept identifier may be performed simultaneously with, or after, the identification of a concept in the review data. In some implementations, sentiment identifiers may be appended to the concept identifiers by a sentiment analysis system 124, which may be done prior to, or after, the addition of the concept identifiers to the review data.

c. Sentiment Analysis System

In some implementations, whether a concept has a positive or negative connotation for a lodging item may be determined through sentiment analysis of the reviews. Sentiment analysis system 124 determines whether a concept has a positive connotation or a negative connotation for an individual lodging item and/or related concept using sentiments within the review data. For example, a concept with a positive connotation for a lodging item may also be referred to as a positive concept for brevity. Similarly, a concept with a negative connotation for a lodging item may also be referred to as a negative concept for brevity. Additionally, whether a concept is a positive concept or a negative concept may vary based on the lodging item. The process for determining whether a concept is a positive concept or a negative concept for each lodging item may be performed by sentiment analysis system 124.

In some implementations, sentiments may be determined or extracted from review data using sentiment analysis system 124. Sentiments may indicate how a lodging item represents a particular concept (e.g., based on the review data). For example, sentiment analysis system 124 determines or extracts sentiment iteratively from each review in the review data and generates positive or negative identifiers for each concept as they relate to a particular lodging item. For example, sentiment analysis system 124 may iterate through each review of the review data and identify sentiments relating to how a concept relates to a lodging item. For example, the review data is reviewed by the learning function 210 so that each mention or instance of a concept in a user review (e.g., there may be multiple mentions of a particular concept) is considered.

In some implementations, for example, a user review may include the phrase “Hotel 1 has a good pool and a bad beach.” Because the term “good” is present, the sentiment analysis system 124 may determine from the context of the review that “pool” is a positive concept for the lodging item “Hotel 1.” Similarly, because the term “bad” is present, the sentiment analysis system 124 may determine that “beach” is a negative concept for “Hotel 1” from the context of the review. Accordingly, sentiment analysis system 124 may generate a first identifier for “pool” (which is positive) as it relates to the lodging item “Hotel 1,” and a second identifier for “beach” (which is negative) as it relates to the lodging item “Hotel 1.” In some implementations, these first and second identifiers may be appended to the concept identifiers in the review data corresponding to those lodging items. With reference to the above example, in some implementations, review data can be labeled with text strings, such as “Hotel 1,” “pool,” and “positive.” In some embodiments, these identifiers could be combined into one identifier (e.g., “Hotel1+pool” or “Hotel1−beach”). In some implementations, numeric or alphanumeric identifiers may be used.

For example, a first user review may include the phrase “Hotel 1 has a good pool and a bad beach.” In some implementations, a numeric identifier may be used for a sentiment score. In some implementations, for example, positive numeric values may be used for positive concept identifiers, and negative numeric values may be used for negative concept identifier. For example, a concept identifier representing the concept “pool” for “Hotel 1” could include a numeric value of +1, and a concept identifier representing the concept “beach” for “Hotel 1” could include a numeric value of −1. This may indicate that statistical analysis of the reviews indicated that most users thought that “pool” was strongly correlated in a positive manner with “Hotel 1,” and that “beach” was strongly corelated in a negative manner with “Hotel 1.” In some implementations, additional information relating to the sentiment's degree of positivity or negativity may be added to the identifier(s). For example, for positive sentiments, a concept frequently associated with a positive sentiment such as “great” or “excellent” in reviews may have a higher score, than a concept frequently associated with “good” or “fine” in reviews. So, for example, if a second user review includes the phrase “Hotel 1 has a great pool,” then a concept identifier representing the concept “pool” for “Hotel 1” in relation to the second user review could include a numeric value of +0.84 and a concept identifier representing the concept “pool” for “Hotel 1” in relation to the first user review (e.g., “ . . . good pool”) could include a numeric value of +0.51. Other means of identifying positive negative concepts for a lodging item are also possible.

In some implementations, the sentiment score/value appended to the concept identifier for a particular lodging item may influence updates or changes made to an embedding space. For example, if “pool” consistently has a higher positive sentiment score than “beach,” as reflected by the labeled review data, a machine learning algorithm may assign “pool” a closer vector location to “Hotel 1” than beach. So, as more review data is processed by the travel service system 108 (e.g., via its various subcomponents), vectors (e.g., representing lodging items and concepts) within an embedding space will be moved around in n-dimensional space (e.g., by adjusting one or more coordinate values associated with each vector) so that the vectors reflect an accurate correlation/relationship between each vector in the embedding space.

iii. Embedding System

Embedding system 116 illustratively relies on one or more training datasets of review data. In some implementations, the review data may be labeled with concepts identifiers and/or sentiment data (e.g., indicating with how sentiments influence the concepts for each lodging item). Then, the labels can be used to generate and assign locations to vectors (e.g., points in an n-dimensional space, each defined with n distinct coordinate values) representing the concepts within a multi-dimensional embedding space.

Embedding system 116 also illustratively generates vectors representing lodging items and concepts. In some implementations, concept identifiers may be identified from review data. In some implementations, other sources of data for generating concept identifiers are also possible. For example, one or more concept identifiers can be derived from search data. In some implementations, lodging items can be identified from a number of sources. For example, a lodging item can be listed on a travel website corresponding to a travel service system (e.g., travel service system 108 of FIG. 1). Lodging items may also be identified from review data, public and/or proprietary databases, web/internet searches, web scraping, APIs, other methods, or some combination thereof.

In some implementations, generation of vectors may begin with creation of initial or preliminary vectors (e.g., each vector corresponding to one of: a lodging item or concept). In some implementations, initial vectors can be generated comprising randomized coordinates in an n-dimensional embedding space. In some implementations, initial vectors can be generated by a machine learning algorithm (e.g., a neural network, or the like) which can use lodging item attributes from one or more sources, for example: user inputs or selections on a website or mobile application, hotel information (e.g., property type, hours of operation, star ratings, user ratings, or the like), amenity information (e.g., free Wi-Fi, free breakfast, pool/spa, or the like), and/or geographic information (e.g., physical address or location) to generate initial vector locations for lodging items. In some implementations, a machine learning algorithm could use statistical information from review data and/or other data sources (e.g., third-party databases) to determine an initial vector location. For example, frequency of a concept “pool” in relation to reviews for “Hotel 1,” may result in an initial vector location for “pool” that is close to the vector representing “Hotel 1.”

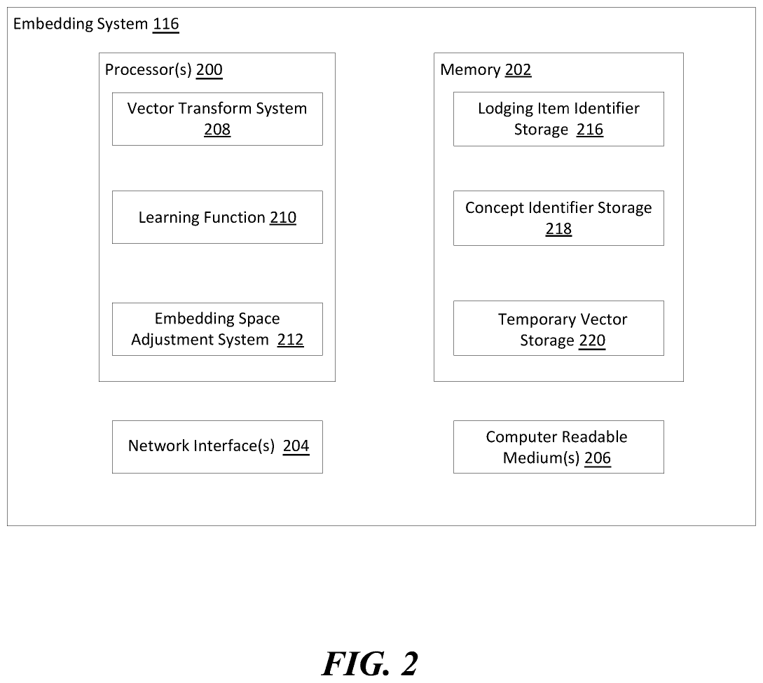

In some implementations, vectors may need to be updated based on new data received (e.g., review data would be constantly updated so that vectors should be updated in relation to the new review data). So, for example, an updated vector (e.g., of any vector currently generated, such as an initial vector or otherwise) can be determined through use of a learning function (e.g., a machine learning model). The learning function can be used to generate updated vectors by updating the coordinates/location of the initial vectors by iterating through review data (e.g., obtained from lodging information database 112 and/or review analysis system 114). For example, assuming there are vectors for “Hotel1” and “spa” in an embedding space and a new user review is received that includes the statement that “Hotel1 has an excellent spa,” then a learning function can be used to generate updated vectors that adjust one or both of the “Hotel1” and “spa” vectors so that the vectors are closer together. In some implementations, other vectors may be adjusted as well during the updating process. For example, even if “Hotel1” and “spa” are the only lodging items and/or concepts mentioned in the new user review, the learning function may also update one or more vectors for other lodging items and/or concepts so that relationships between all vectors in the embedding space remain correlated in a way consistent with all user reviews previously processed by the learning function. In some implementations, vectors (e.g., initial, updated, or other states) may be stored in the vector database 118. Additional features of the embedding system 116 is described further herein (e.g., with regards to FIG. 2).

iv. Vector Database

Travel service system 108 of FIG. 1 includes a vector database 118. Vector database 118 is illustratively configured to store one or more vectors generated by embedding system 116. Additionally, or alternatively, vectors generated by embedding system 116 may be stored in a memory of embedding system 116.

Each vector (e.g., stored within the vector database 118) illustratively includes a predefined number ‘n’ of coordinates, effectively positioning the vectors at explicit locations within the n-dimensional embedding space. These locations/positions are indicative of certain relationships or correlations amongst the vectors. For example, the closer two vectors are to each other (the shorter the distance between them), the more correlated the two vectors would be (e.g., as determined by a learning function, machine learning model, or the like). For example, the distance can be measured using similarity measures such as one or more of: inner product, cosine similarity, dot product, Euclidean distance, or other similar functions.

In some implementations, the data structure utilized for storing each vector in the database includes of a unique identifier for the vector and an array of ‘n’ scalar values. The unique identifier enables efficient retrieval and manipulation of vectors, whereas the array of scalar values represents the ‘n’ coordinates of the vector in the embedding space. In some implementations, the vectors are stored (e.g., within the vector database 118) as individual records, each including the unique identifier and the corresponding array of ‘n’ coordinates. In some implementations, the vector database 118 can provide functionality for adding, deleting, and updating these vectors as needed, thereby allowing the underlying n-dimensional embedding space to be dynamically modified (e.g., based on new review data being processed by the travel service system 108).

v. Search System

Search system 120 is illustratively provided such that users can submit a request for lodging items (e.g., via one or more user device(s) 102, or the like). For example, a user may enter a query including one or more concepts (e.g., in some cases with one or more sentiments) via a website, mobile application, or API (e.g., operated by a travel service system 108). The entered user query, for example, may be processed by the search system 120 to decipher the user's intent and to extract at least one concept (e.g., a first concept).

In a first example, the search system 120 can identify a first vector representing the first concept within the vector database 118. Then, the search system 120 can use the coordinates/location assigned to the first vector to identify one or more lodging items related to the first concept (e.g., where the lodging items would include a location/coordinates that are nearby the first concept). Then, in some implementations, the resulting/identified lodging items can be transmitted to the user as search results (e.g., the travel service system 108 can generate and transmit display instructions configured to present the search results in a graphical user interface of a user device operated by the user running the search/query). In some implementations, the search results may be filtered or ranked by one or more parameters, including, but not limited to, price, availability, another parameter, or some combination thereof. For example, filtering refers to the process of removing certain results based on specific criteria, and ranking refers to the process of ordering the remaining results based on certain metrics.

In a second example, the search system 120 can identify a first vector representing the first concept within the vector database 118. Then, the search system 120 can use the coordinates/location assigned to the first vector to identify one or more lodging items in the same embedding space as the first vector (e.g., where the one or more lodging each correspond to a location/coordinates). Then, the search system 120 can rank or order the one or more lodging items based on distance to the first vector. Then, in some implementations, at least a portion of the resulting/identified lodging items (e.g., the closest 1, 3, 5, 10, etc. lodging items to the first vector) can be transmitted to the user as search results (e.g., the travel service system 108 can generate and transmit display instructions configured to present the search results in a graphical user interface of a user device operated by the user running the search/query).

In a third example, the entered user query, for example, may be processed by the search system 120 to decipher the user's intent and to extract two or more concepts. In some implementations, the search system 120 can determine a centroid between all of the two or more concepts and use coordinates corresponding to the centroid to identify one or more lodging items (e.g., by implementing the first example or second example described in this section).

In a fourth example, and similar to the third example, the entered user query, for example, may be processed by the search system 120 to decipher the user's intent and to extract two or more concepts. In some implementations, the search system 120 can generate search results for each of the two or more concepts (e.g., by implementing the first example or the second example). For example, multiple searches can be implemented to identify lodging items that are close to each concept vector identified by the search system 120. Then, the search results can be intermixed based on the set of results from the multiple searches. The intermixed set of results, for example, can be mixed or combined and then ordered, ranked, or filtered.

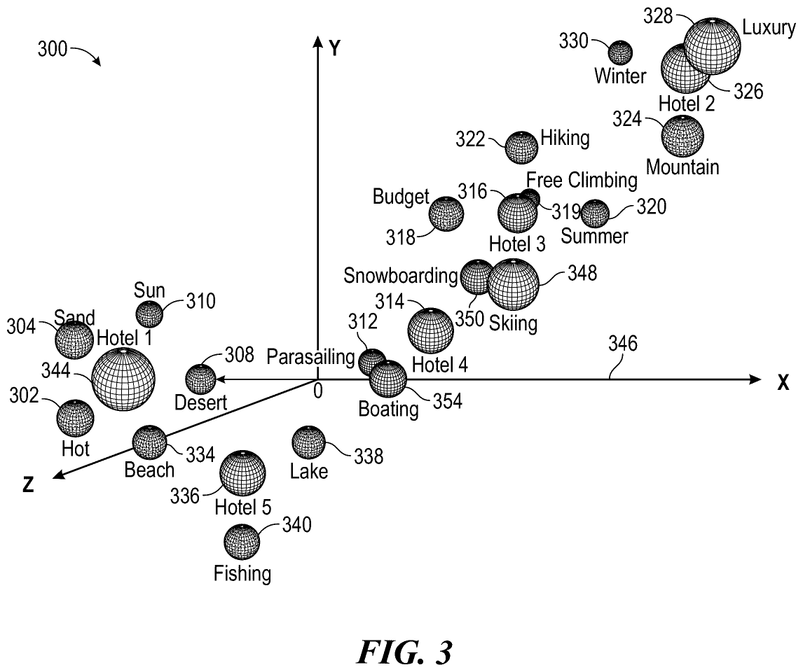

In some implementations, search system 120 (e.g., by referring to the vector database 118) provides a querying mechanism enabling the retrieval of vectors based on their proximity in the n-dimensional embedding space. For example, given a query, the travel service system 108 can identify and return the vectors relevant to the query, measured as the distance between concepts and/or lodging items in the embedding space. For example, given a user query for “skiing” so that a particular user may be interested in finding a hotel that provides opportunities to ski, the travel service system 108 (e.g., by referring to the vector database 118) can first identify a location of “skiing” or “ski” in the embedding space. Then, travel service system 108 (e.g., by referring to the vector database 118) can find lodging items that are correlated to “skiing” by retrieving lodging item vectors close to the “ski” vector in the embedding space, such as Hotel 3 or Hotel 4 in FIG. 3.

In some implementations, the travel service system 108 may limit the results provided to a user (e.g., based on a query). For example, in some implementations, the travel service system 108 may include a preconfigured or dynamically adjusted threshold applied to limit the number of results provided to the user and/or to limit results that may not be relevant. For example, there may be a specific distance in an embedding space where any returned results (e.g., lodging items) to a query may not be useful to the user running the query. In some implementations, the specific distance can be preconfigured by the user running the query or by an administrator operating the travel service system 108. In some implementations, the specific distance can be dynamically determined by the travel service system 108 (e.g., based on the number of results desired, based on the total number of concepts or lodging items in the embedding space, based on processing power of the travel service system 108 server or user device running the query, based on internet speed between travel service system 108 server and the user device running the query, based on a machine learning algorithm or learning function, or a combination of factors). Also, for example, it may be desired to present only a certain number of results (e.g., lodging items) to a user running the query, such as 5, 10, 20, etc. results. So, in some implementations, the travel service system 108 can search for (e.g., in the vector database 118) only the number of results desired such as to conserve processing power and/or execute the search more quickly. In some implementations, the travel service system 108 can search for (e.g., in the vector database 118) as many hits (e.g., lodging items) as available (e.g., within a specific distance in the embedding space) and then rank and filter the number of results so that the top 5, 10, 20, etc. results are provided to the user (e.g., via a graphical user interface) for selection by the user.

### II. Embedding System

FIG. 2 is a block diagram of example components of an embedding generation system 116 (e.g., as shown in FIG. 1), according to various aspects of the present disclosure. The embedding system 116 includes, at least, one or more of: processor(s) 200, memory 202, a network interface(s) 204, and computer readable medium(s) 206. Embedding system 116 may include one or more of each subcomponent. In addition, on some embodiments, the subcomponents of embedding system 116 may be connected across multiple systems. In some implementations, for example, the subcomponents may communicate through network 110, or through another network, such as a local network, where network interface 204 may be used to facilitate any such communication between systems. In some implementations, one or more subcomponents may perform the role of one or more other subcomponents or systems. It is also recognized that there are other implementations of the embedding system 116, which may exclude certain subcomponents and/or include additional components.

a. Processor(s)

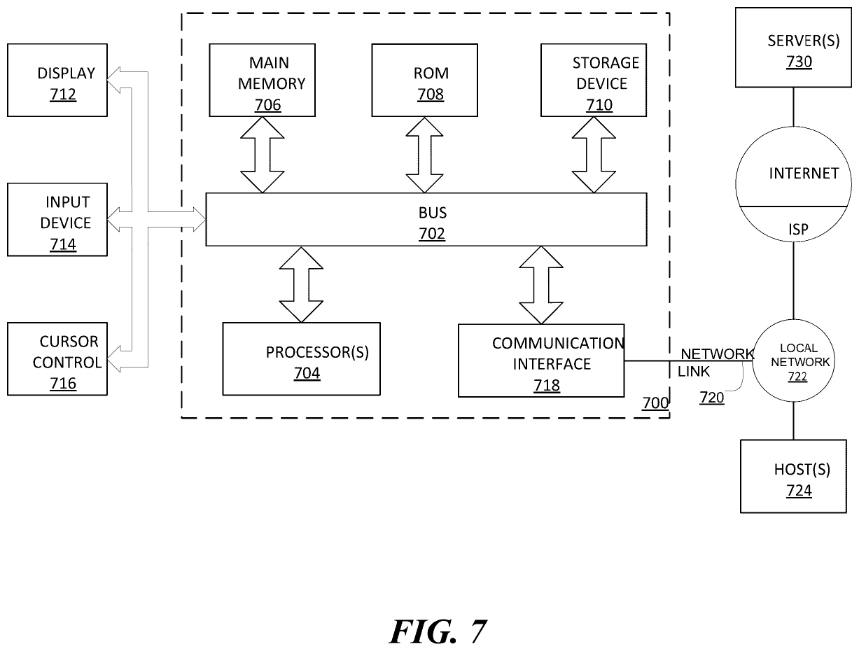

Processor(s) 200 illustratively include additional subcomponents such as: vector transform system 208, learning function 210, and embedding system 212. In some embodiments, instructions for the subcomponents of processor 200 may be stored in memory 202. In some implementations, processor(s) are the same or similar to processor(s) 704 described in relation to FIG. 7.

i. Vector Transform System

Vector transform system 208 generates vectors representing various concepts and/or lodging items. The vectors may include, for example, a location (e.g., coordinates) which is representative of a position within a multi-dimensional embedding space. As further discussed herein, the embedding space is a concept to allow the capture of contextual information representing the relationship between what the vectors represent. In some implementations, and as further discussed herein, initial or preliminary vector locations may be set at random, based on information about the concepts or lodging items received by vector transform system 208, another method, or some combination thereof.

In some implementations, embedding system 116 may receive information pertaining to lodging items (e.g., from lodging information database 112 of FIG. 1). In some implementations, the information pertaining to lodging items may include: identification of one or more lodging items, identification of attribute information (e.g., concepts or other salient features that can be used to describe lodging items) associated with lodging items. Based at least in part on this information, vector transform system 208 can generate a lodging item vector for each identified lodging item (e.g., with an initial vector location). In some implementations, the initial vector location may be based on attributes included in the obtained lodging item information. In some implementations, the initial vector location for the lodging item vector may also be set at random.

In some implementations, the embedding system 116 generates vectors representing lodging items and concepts. In some implementations, concept identifiers may be identified from review data. In some implementations, other sources of data for generating concept identifiers are also possible. For example, one or more concept identifiers can be derived from search data. In some implementations, lodging items can be identified from a number of sources. For example, a lodging item can be listed on a travel website corresponding to a travel service system (e.g., travel service system 108 of FIG. 1). Lodging items may also be identified from review data, public and/or proprietary databases, web/internet searches, web scraping, APIs, other methods, or some combination thereof.

In some implementations, generation of vectors may begin with creation of initial or preliminary vectors (e.g., each vector corresponding to one of: a lodging item or concept). In some implementations, initial vectors can be generated comprising randomized coordinates in an n-dimensional embedding space. In some implementations, initial vectors can be generated by a machine learning algorithm (e.g., a neural network, or the like) which can use lodging item attributes from one or more sources, for example: user inputs or selections on a website or mobile application, hotel information (e.g., property type, hours of operation, star ratings, user ratings, or the like), amenity information (e.g., free Wi-Fi, free breakfast, pool/spa, or the like), and/or geographic information (e.g., physical address or location) to generate initial vector locations for lodging items. In some implementations, a machine learning algorithm could use statistical information from review data and/or other data sources (e.g., third-party databases) to determine an initial vector location. For example, frequency of a concept “pool” in relation to reviews for “Hotel 1,” may result in an initial vector location for “pool” that is close to the vector representing “Hotel 1.”

In some implementations, vectors may need to be updated based on new data received (e.g., review data would be constantly updated so that vectors should be updated in relation to the new review data). So, for example, an updated vector (e.g., of any vector currently generated, such as an initial vector or otherwise) can be determined through use of a learning function (e.g., a machine learning model). The learning function can be used to generate updated vectors by updating the coordinates/location of the initial vectors by iterating through review data (e.g., obtained from lodging information database 112 and/or review analysis system 114). For example, assuming there are vectors for “Hotel1” and “spa” in an embedding space and a new user review is received that includes the statement that “Hotel1 has an excellent spa,” then a learning function can be used to generate updated vectors that adjust one or both of the “Hotel1” and “spa” vectors so that the vectors are closer together. Also, assuming one or both of the “Hotel1” and “spa” vectors are updated, then the relative similarities between the updated “Hotel1” vector and/or “spa” vector and other concepts and/or hotels in the embedding space will also consequently be updated. In some implementations, vectors (e.g., initial, updated, or other states) may be stored in the vector database 118. Additional features of the embedding system 116 is described further herein (e.g., with regards to FIG. 2).

ii. Learning Function

In some implementations, a learning function 210 (e.g., a model, machine learning model, neural network, or the like) may be trained to generate, update, locate, or output vectors representing lodging items and/or concepts, where the vectors include coordinates/locations in a multi-dimensional embedding space. In some implementations, the learning function may generate, update, or determine vector features (e.g., coordinates, labels, etc.) and calculate distance between vectors such as by using one or more similarity functions (e.g., inner product, cosine similarity, dot product, Euclidean distance, or other similar functions). In some implementations, training data (e.g., labeled and/or unlabeled review data) for the learning function 210 may be stored in lodging information database 112 and accessed by embedding system 116 described by FIG. 1.

In some implementations, for example, the learning function 210 may determine an initial similarity between identified concepts and lodging items (e.g., distance in the embedding space between two vectors). The learning function may then determine the accuracy, precision, and/or certainty of this similarity. For example, the learning function 210 may receive a lodging item (e.g., “Hotel 1”) as an input, a positive concept for that lodging item (e.g., a positive concept may be the “view” based on a user review stating that “Hotel has a beautiful view”), and a negative concept for that lodging item (e.g., a negative concept may be the “smell” based on a user review stating that “Hotel has a smelly gym”), and use a loss function to generate a score for the relationships between the positive concept and the lodging item as well as the negative concept and the lodging item. In some implementations, individual reviews (e.g., from a labeled review dataset) may be input into learning function 210 in an iterative manner, and locations of concept and lodging item vectors may be adjusted based on the score provided by learning function 210. Examples of vector generation and updating/adjustments are described in more detail here (e.g., with regards to FIGS. 3-5).

iii. Embedding Space Adjustment System

In some implementations, embedding space adjustment system 212 can update vector locations/coordinates for vectors in a multi-dimensional embedding space (e.g., based on new data or information received). For example, supplemental review data may be obtained by travel service system 108 which may then be labeled. This supplemental review data may be input by embedding space adjustment system 212 into learning function 210 to generate updated vectors (e.g., updating coordinates/locations corresponding to one or more vectors in the embedding space) in consideration of the supplemental review data. In some implementations, the updated vectors may be stored in memory 202. In addition, in some implementations, there may be a vector removal model/tool that can be used to remove certain lodging items and/or concept vectors (e.g., based on rules set by a user, based on supplemental review data indicating that a lodging item is closed or unavailable, or the like).

b. Memory

In some implementations, memory 202 may include RAM, ROM or other persistent or non-transitory memory. In some implementations, memory 202 may store computer executable instructions for use by processor(s) 200 or one or more subcomponents of the processor(s) 200. For example, memory 202 includes computer executable instructions that, when executed, implement processes 208, 210, and/or 212. In some implementations, training datasets (e.g., training datasets obtained from lodging information database 112 as described in FIG. 1) may also be stored in memory 202. In some implementations, memory 202 is the same or similar one or more components described in relation to FIG. 7 (e.g., main memory 706, rom 708, and/or storage device 710

i. Lodging Item Identifier Storage

In some implementations, lodging item identifiers can be stored in lodging item identifier storage 216. For example, vector transform system 208 may access lodging item identifiers to generate vectors representing the lodging items (e.g., by using a machine learning algorithm such as learning function 210). In some implementations, once vectors are generated, the learning function 210 and/or embedding space adjustment system 212 can be used to update the locations/coordinates of the lodging item vectors (e.g., based on review data or supplemental review data received by the travel service system 108).

ii. Concept Identifier Storage

In some implementations, concept identifiers may be stored in item concept identifier storage 218. For example, vector transform system 208 can access the concept identifiers to generate vectors representing the concepts (e.g., by using a machine learning algorithm such as learning function 210). In some implementations, once vectors are generated, the learning function 210 and/or embedding space adjustment system 212 can be used to update the locations/coordinates of the concept vectors (e.g., based on review data or supplemental review data received by the travel service system 108).

iii. Temporary Vector Storage

In some implementations, memory 202 may also store vectors, including locations/coordinates, and other information in temporary vector storage 220. For example, updated vectors may be temporarily stored in temporary vector storage 220. For example, a training session may be considered complete when all available review data has been iteratively reviewed/processed by learning function 210. While the training session is ongoing, current vector data may be stored in temporary vector storage 220. Once the training session is complete, the vector data may be stored in another vector database (e.g., vector database 118 of FIG. 1). In some implementations, vector database 118 and temporary vector storage 220 are the same.

c. Network Interface

In some embodiments, network interface 204 may be used to provide connectivity to one or more networks or computing systems. For example, in some embodiments, network interface 204 may provide connectivity to user devices 102, lodging item database(s) 104, and/or third-party review services of FIG. 1. Additionally, or alternatively, network interface 204 may provide connectivity between subcomponents of travel service system 108. In some implementations, network interface 204 is the same or similar to network 110 in FIG. 1, communication interface 718 in FIG. 7, and/or network link 720 in FIG. 7.

d. Computer Readable Medium Drive

In some embodiments, the computer readable medium drive 206 may allow direct connection to embedding system 116. This connection can be used to directly communicate with embedding system 116. Additionally, or alternatively, computer readable medium drive 206 may be involved in carrying one or more sequences of one or more computer readable program instructions to processor 200 for execution. In some implementations, computer readable medium drive 206 is the same or similar to one or more components described in FIG. 7 (e.g., main memory 706, rom 708, and/or storage device 710).

### III. Example Embedding Space

FIG. 3 is an illustrative diagram representing an example three-dimensional embedding space 300, according to various aspects of the present disclosure. For the purposes of simplicity while describing the example embedding space, a three-dimensional axis 346 is presented to help illustrate the dimensionality of the space. However, in some implementations, an embedding space can be represented by greater or fewer quantity of dimensions. For example, an embedding space may be represented by 32 dimensions such that each vector within the embedding space would include 32 scalar values that can be used as coordinates in the embedding space.

In some implementations, dimensionality of the space (and also dimension of each vector) may be chosen to balance an improved accuracy with memory/processing requirements (e.g., which may affect speed of updating the vectors, querying the vectors, etc.). In some implementations, an admin or person can select or determine the dimensionality of an embedding space (e.g., empirically, to optimize for speed, to optimize for accuracy, or optimize for a variety of factors). In some implementations, a machine learning model can select or determine the dimensionality of an embedding space. For example, if computer resources are limited, dimensions may be reduced to provide more speed and/or require less energy. Also, for example, dimensions may be increased to provide more accuracy or reliability in the resulting embedding space. In some implementations, a machine learning model can update a selected dimensionality of an embedding space. For example, if computer resources are upgraded, dimensionality can be increased as well. In some implementations, where a machine learning model selects the dimensionality, the machine learning model can do so by selecting a set of features or variables to be reviewed/analyzed by the machine learning model. For example, such relevant features may include, but are not limited to: semantic features (e.g., sentiment, topical relevance, etc.), location in the embedding space, patterns learned by training (e.g., not reflected in the input data), other features, or some combination thereof. In some implementations, dimensions within a concept vector may include, but are not limited to, the concept identifier, sentiment information with respect to one or more lodging items, a location within the embedding space, another feature, or some combination thereof.

Referring back to FIG. 3, in embedding space 300, vectors are illustrated by spheres to aid in visualizing multi-dimensional embedding space. However, vectors would be a point in the space. For example, in a higher dimensional embedding space, the vectors would be a point as well. In FIG. 3, the size of the spheres in the embedding space is the same among all spheres; however, to illustrate relative position, spheres closer to the viewer of FIG. 3 are illustrated to be larger than the spheres that are farther away from the viewer. For example, the Hotel 1 vector 344 appears larger than Hotel 5 vector 336, denoting that Hotel 1 vector 344 is closer to the viewer of FIG. 3. This indicates that Hotel 1 is closer to the front of the visualization.

In FIG. 3, lodging item vectors represented in three-dimensional embedding space 300 include hotel 1 vector 344, hotel 2 vector 326, hotel 3 vector 316, hotel 4 vector 314, and hotel 5 vector 336. These lodging item vectors are surrounded by one or more concept vectors (e.g., which can be determined from review data). In some implementations, concepts may be extracted based on frequency of appearance in the review data, a determined relevancy to users, another parameter, or some combination thereof. Accordingly, concepts can include some of following non-limiting examples: weather, nearby landmarks, landmark characteristics, season, pricing, activities, and/or the like. For example, concept vectors may represent the weather, such as hot vector 302 or sun vector 310. Concept vectors may also represent nearby landmarks such as, desert vector 308, beach vector 334, and lake vector 338, or they may represent characteristics of a landmark, such as sand vector 304. Concept vectors may additionally represent a quality of a lodging item, such as luxury vector 328, budget vector 318, or they may represent a season, such as summer vector 320 or winter vector 330. In addition, concept vectors may represent activities, such as fishing vector 340, boating vector 334, parasailing vector 312, skiing vector 348, snowboarding vector 330, free-climbing vector 319, hiking vector 322, or mountain vector 324.

Concept vectors may be closer or further away from a lodging item vector in embedding space 300 based on a determined similarity between the represented concept and/or lodging item. For example, luxury vector 328 may have a first location (coordinates: x₁, y₁, z₁) in the embedding space that is close to a second location of hotel 2 vector 326 (coordinates: x₂, y₂, z₂). This would mean that an embedding system (e.g., embedding system 116 of FIGS. 1-2) has determined that the “luxury” concept and lodging item “hotel 2” may be closely related and/or correlated (e.g., based on review data). For instance, because the determination is made based on information from human-written reviews, the human understanding of the relationship between the concepts and the vectors may be better represented to the machine in the embedding space.

In one example, assuming a travel service system 108 is using the simplified embedding space 300 in FIG. 3, if a user provides a search query to a travel service system 108 for “hotels with where I can snowboard”, the travel service system 108 would first locate the most similar concept “snowboarding” as vector 350 and compare distances between vector 350 and lodging items in the embedding space. Based on the distance calculation, Hotel 3 vector 316 and Hotel 4 vector 314 could be returned to the user for display on the user's user device (e.g., via a graphical user interface for selection).

### IV. Example Flows

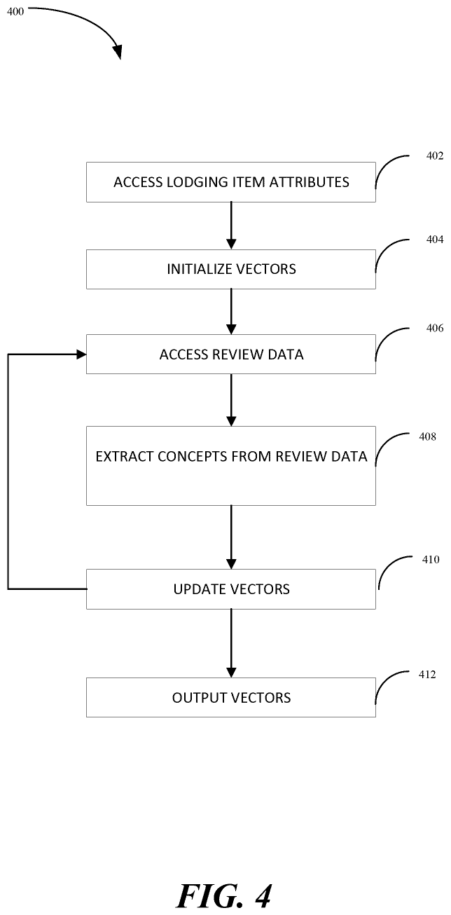

FIG. 4 is a flow diagram 400 for creating or updating embeddings or vectors for an embedding space, according to various aspects of the present disclosure. Some of the processes, steps, and/or modules discussed herein may be combined, separated into sub-parts, omitted entirely, and/or rearranged to run in a different order and/or in parallel. In addition, in some embodiments, different blocks may execute on various components of an embedding system (e.g., 116 of FIG. 1).

At block 402, an embedding system (e.g., embedding system 116 of FIG. 1) accesses lodging item attributes. In some implementations, other components of a travel service (e.g., travel service system 108) may also be used to access lodging item attributes. In some implementations, lodging item attributes can be stored in a lodging information database (e.g., lodging information database 112 of FIG. 1). In some implementations, lodging item attributes may be extracted from review data. In some implementations, lodging item attributes include concepts and/or other features that can be used to describe lodging items. For example, lodging item attributes may include, but are not limited to: lodging item identifiers, physical locations of hotels, concept information, availability data (e.g., availability of rooms), pricing information, and the like.

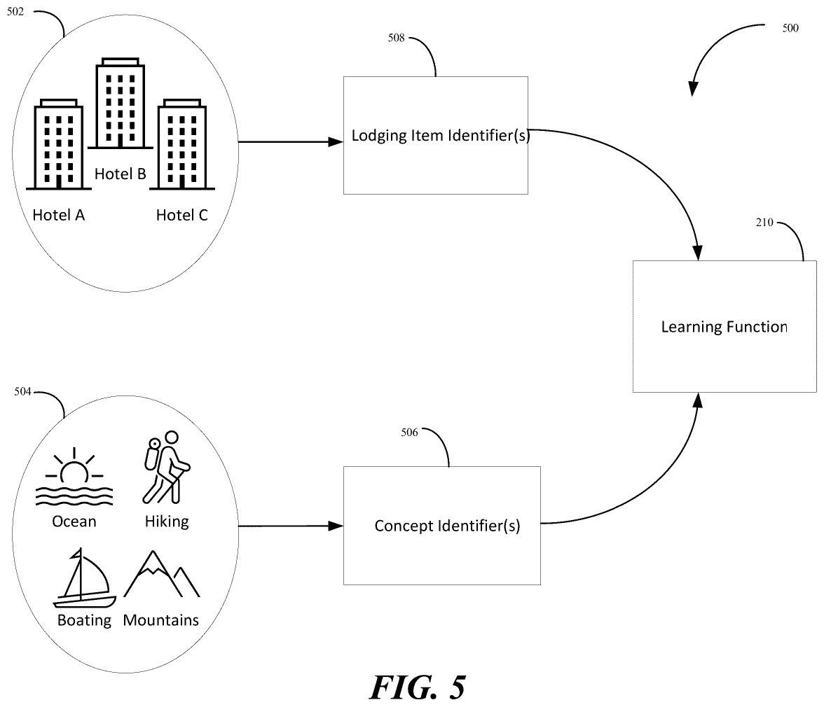

At block 404, the embedding system generates or initializes an initial vector location for vectors representing lodging items in an embedding space. To implement this, for example, the embedding system may access a pool of lodging item identifiers representing lodging items and initialize lodging item vectors at least by determining an initial vector location for each of those lodging items. In some implementations, initial vector locations for lodging items may be set at random. In some implementations, initial vector locations for lodging items may be based in part on lodging item attributes. For example, lodging item identifiers (e.g., item identifiers 506 FIG. 5) and the physical location of the hotel may be used to generate initial vector locations. For example, with reference to FIG. 3, Hotel 5 may share a close physical proximity or address to Hotel 1. Accordingly, Hotel 1 vector 344 and Hotel 5 vector 336 may be provided initial vector locations that are close together within the embedding space 300. The assumption being that if two lodging items are close in the real/physical world, they will likely share weather, activities, etc. and would therefore likely be similarly situated in an embedding space. Alternatively, and in some implementations, vectors for lodging items and/or concepts can be initialized or generated upon first encounter (e.g., in a user review) so that the embedding space includes only lodging item vectors and/or concept vectors that are identified in training data set(s) (e.g., user reviews) that have been used to train or update the model generating the vectors for the embedding space.

At block 406, a review analysis system (e.g., review analysis system 114 of FIG. 1) accesses review data. In some implementations, review data may be stored in lodging information database (e.g., lodging information database 112 of FIG. 1). For example, the review analysis system may obtain the review data from the lodging information database. In some implementations, other components of a travel service (e.g., travel service system 108 of FIG. 1) may also be used to access review data. The review data may then be transmitted to the review data analysis system. In some implementations, the review data comprises a plurality of reviews, each review corresponding to at least one lodging item of a plurality of lodging items, including at least one concept among a plurality of concepts, and indicating at least one sentiment associated with the at least one concept.

At block 408, concept information is extracted from the review data. For example, in some implementations, the review data may be processed by a review analysis system (e.g., review analysis system 114 of FIG. 1) to generate concept identifiers. In some implementations, the concept identifiers may be associated with a sentiment (e.g., positive or negative, and/or a degree of positivity or negativity). For example, a sentiment may reflect a positive or negative connotation pertaining to a relationship between a concept and a lodging item. In some embodiments, deciphering sentiments as they modify concepts in a user review for one or more lodging items may be derived from proximity of words within a sentence or other contextual information and stored within the user review. For example, concepts may be determined from analysis of the statistical data for the review data. Also, for example, a classification algorithm (e.g., a neural network) may be used to determine sentiments from review data. Additionally, for example, sentiments may be determined from sentence level analysis of each review in the review data. Furthermore, in some implementations, a review analysis system (e.g., review analysis system 114 of FIG. 1) can be configured to identify, from the review data, a set of associations. For example, each association of the set of associations can indicate that each review of the plurality of reviews: corresponds to a particular lodging item from the plurality of lodging items, includes a particular concept from the plurality of concepts, and indicates a particular sentiment.

In some implementations, the concept identifier and associated sentiment classification may be used to label the review data (e.g., as described with reference to FIG. 1). In some implementations, the review analysis system may be used to initialize concept vectors. Additionally, in some implementations, an embedding system (e.g., embedding system 116) may be used to initialize concept vectors, based at least in part on the concept identifiers used to label the review data. For example, in some implementations, the embedding system may assign locations to concept vectors in the same embedding space as the lodging item vectors.

In some implementations, the initial vector location for the concept vectors may be set at random. In some implementations, the initial vector position may also be set based on statistical data for each concept within the review data. For example, an initial vector location for a concept may be set based on the frequency of its appearance in reviews for lodging items. For example, a first concept vector representing a first concept that occurs with a high frequency with respect to a first lodging item may receive an initial vector location relatively close to the vector representing that lodging item in the multi-dimensional embedding space. With reference to FIG. 3, for example, the concept “beach” appearing frequently in reviews for both Hotel 1 and Hotel 5 may result in the “beach” vector 334 having an initial location between hotel 1 vector 344 and hotel 5 vector 336. In some implementations, the determined vector locations for the lodging item vectors and concept vectors may change as new or supplemental review data is processed by an embedding system (e.g., embedding system 116 of FIG. 1).

At block 410, the vector or embedding locations (e.g., coordinates) are generated (e.g., if not previously generates) or updated (e.g., if previously generated) based on new or supplemental review data (e.g., going back to repeat blocks 406 and 408). For example, review data may be labeled, and concept and lodging identifiers then input into a learning function (e.g., discussed in more detail with respect to FIG. 5). In some implementations, block 410 includes generating a set of embeddings or vectors for each of the plurality of lodging items and each of the plurality of concepts, the set of embeddings locating each lodging item and each concept within a shared multi-dimensional embedding space. For example, generating the set of embeddings comprises, for each of the set of associations, modifying a distance between the particular lodging item of the association and the particular concept included in the association based at least in part on the particular sentiment of the association. In some implementations, updates may occur at intervals. For example, intervals may be a set amount of time (e.g., a day, a month, etc.), upon request by an administrator or user, when a certain quantity of new or supplemental review data reaches a threshold (e.g., 1000 reviews, 1 terabyte (TB), etc.), another type of interval, or some combination thereof.

At block 412, the updated vectors or embeddings from block 410 may be stored (e.g., in one or more data stores or memories) and/or output for use in improving travel services or travel searches. For example, the vectors or embeddings may be transmitted to a vector database (e.g., vector database 118 of FIG. 1) and accessed by a search system (e.g., search system 120 of FIG. 1) to respond to user search queries. In some implementations, the vectors or embeddings may include locations within an embedding space, as described above.

FIG. 5 is an illustrative block diagram showing an example of generating vectors for lodging items and concept information, according to various aspects of the present disclosure. FIG. 5 illustrates an example two-tower architecture where one tower processes lodging items 502 and the other tower processes concepts 504. However, other implementations of architectures (e.g., other two-tower architectures) may be used to implement the concepts disclosed herein. In some implementations, the flow shown in FIG. 5 may be implemented by a travel provider, such as travel service system 108 of FIG. 1. For example, the travel service may use an embedding system (e.g., embedding system 116 of FIG. 1) to implement the flow.

In some implementations, lodging items 502 and concepts 504 may be accessed to provide input to an embedding system. For example, lodging items 502 may include information for one or more lodging items, such as “Hotel A,” “Hotel B,” and “Hotel C.” Also, for example, concepts 504 may include information relating to one or more concepts, such as “Ocean,” “Hiking,” “Boating,” and “Mountains.” While FIG. 5 depicts separate groupings for lodging items and concepts, in some implementations, both concepts and lodging items may be included in review information.

In some implementations, lodging items 502 and concepts 504 may be processed (e.g., by review analysis system 114 of FIG. 1) to generate lodging item identifiers 508 and/or concept identifiers 506, respectively. For example, lodging items 502 and concepts 504 may be obtained by a travel service through a network (e.g., travel service system 108 and network 110 of FIG. 1). In some implementations, a travel service may analyze review data to extract lodging item identifiers and/or concept identifiers (e.g., as described with respect to FIG. 1). However, in some implementations, lodging item identifiers 508 may be accessed prior to identification of concepts 504 from review data. For example, in some implementations, a travel provider may maintain a list of lodging item identifiers 508 for lodging items 502 on their website or mobile application.

In some implementations, once an embedding system has accessed the lodging items 502 and/or concepts 504, the embedding system may initialize a vector for each underlying lodging item 502 and/or concept 504 at least by providing an initial location for each vector (e.g., as discussed with respect to FIG. 4). In some implementations, through use of a learning function 210, for example, locations for the initialized vectors may be updated by utilizing review data labeled to identify concepts and sentiments as they relate to one or more lodging items.

In some implementations, whether a concept is positive or negative may be more difficult to discern. For example, a review may contain the phrase “Hotel B has small cozy rooms but an excessively ornate lobby.” In this review, “Hotel B” may be a lodging item, “rooms” and “lobby” may be concepts, and “small,” “cozy,” “excessively,” and “ornate” may be sentiments. Here, a human may easily discern that “rooms” may be a positive concept, and “lobby” may be a negative concept for Hotel B. By iterating through the review data, the learning function 210 can iteratively adjust each vector location in the embedding space based in part on how differences in language (e.g., for sentiments, concepts, etc.) reflect the relationship between the concepts and lodging items. For example, the review data is reviewed by the learning function 210 so that each mention or instance of a concept in a user review (e.g., there may be multiple mentions of a particular concept) is considered.

In some implementations, to adjust vector locations, learning function (e.g., 210) may first calculate similarity metrics between lodging items and concepts. Techniques for similarity calculation may include, but are not limited to, cosine similarity, inner product, or Euclidian distance functions. The result of these similarity calculations may be provided to a loss function to determine whether to update the vector locations. For example, loss functions (e.g., mean squared error, cross-entropy, triplet loss, etc.) quantify a discrepancy between an expected value and an actual value, and loss functions may be used with similarity metrics to improve the representation of relationships present within an embedding space.

In some implementations, the learning function may use both a similarity function and a ranking loss function (e.g., a triplet loss function) to iteratively update concept vector and lodging item locations within an embedding space. For example, triplet loss functions first generate a similarity between an anchor and a positive example, and another similarity between an anchor and a negative example. A score reflecting the similarity and dissimilarity, respectively, may then be calculated for the positive and negative examples with respect to the anchor. Also, for example, triplet loss may also use a margin, where the margin indicates a difference between positive and negative scores at which loss is considered minimized. Overall loss is then calculated using a combination of the positive scores, negative scores, and margin. When used with a model generating vectors in an embedding space, the vector locations may then be updated to minimize loss.

In some implementations, to calculate updated vector locations, the learning function may follow the method described above with respect to triplet loss functions. In some implementations, other loss functions may also be used. In implementations using a triplet loss function, the anchor may be a lodging item. In some implementations, the positive example may be a concept determined to have a positive connotation with respect to the lodging item, and the negative example may be a concept determined to have a negative connotation with respect to the lodging item. As discussed above, the positive and negative connotations of the concepts with respect to the review data may stem from analysis of the sentiment data in each review.

In some implementations, to train the model or learning function, a first step can be to define positive and negative (e.g., which can be used to calculate a ranking loss). For example, the model may first calculate a positive score relating to the similarity between the positive concept and the lodging item, and a negative score reflecting the dissimilarity between the negative concept and the lodging item. For example, a score may be calculated using a similarity function (e.g., cosine similarity or inner product), also referred to as ƒ(h, c), where “h” is a lodging item represented by a vector vₕ and a “c” is a concept represented by a vector v_{c}. In some implementations, a positive score may be calculated for a positive concept c⁺ may be determined from review data using the function ƒ(h, c⁺)=vₕ·v_{c}_{⁺}. Similarly, a negative score may be generated for negative concept c⁻ may be extracted from review data. A similarity between the concept and a lodging item h can could be calculated using the function ƒ(h, c⁻)=vₕ·v_{c}_{^{−}}.

In some implementations, the learning function 210 may then use a ranking loss function (e.g., a triplet loss function) that may take the following form: L=max{0, m−ƒ(h, c⁺)+ƒ(h, c⁻)}, where m is the margin. In some embodiments, further rules may be applied to the output to increase the likelihood that accurate relationships are being captured. For example, to avoid trivial solutions, in some implementations, hard negatives may be selected with the following rule: ƒ(h, c⁻)>ƒ(h, c⁺)+m.

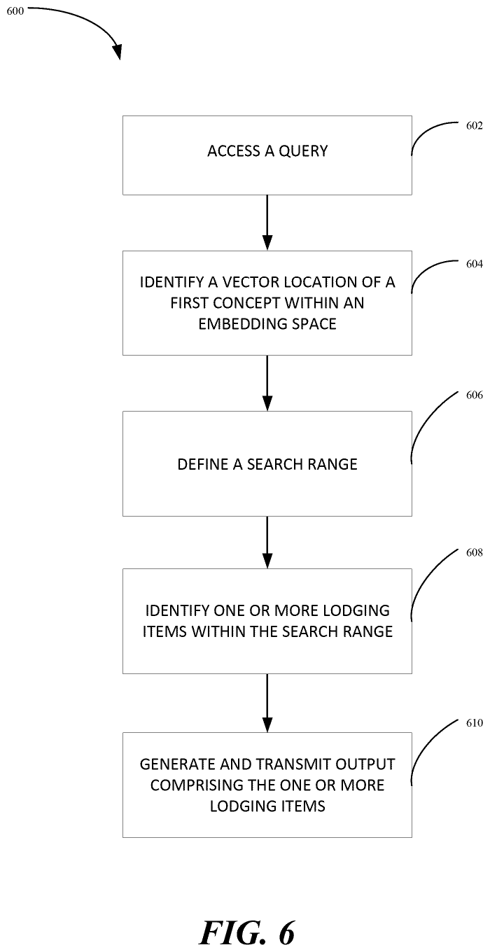

FIG. 6 is a flow diagram showing an example 600 of processing user submitted search queries, according to various aspects of the present disclosure.

At block 602, a query is accessed that includes one or more concepts. In some implementations, the query may be accessed through user input into a search system (e.g., typed input, voice command, etc.). For example, a user may submit the query “hotels with beaches,” into a travel website or application (e.g., a travel website hosted by travel service system 108 of FIG. 1) with a user device (e.g., device(s) 102 of FIG. 1). In some implementations, a search system (e.g., search system 120 of FIG. 1) may extract any concepts identified in submitted search queries. For example, to extract concepts from a user query, the search system may first split the query into individual words (e.g., in a tokenization process). In the example provided, “hotels with beaches” may be split into “hotels,” “with,” and “beaches.” The search system may then use a model trained to recognize those terms (e.g., a named entity recognition model) to identify the concepts. For example, “beaches” may be recognized as a concept. In some implementations, the search system may search for the terms of the query in a concept identifier storage (e.g., concept identifier storage 218 of FIG. 2). In some implementations, once the concepts are identified, the search system may look for vectors identified in the submitted query.

At block 604, the search system searches for, and identifies, a vector location of a vector representing the first concept. To do this, for example, the search system can query a vector database (e.g., vector database 118 of FIG. 1) for a concept identifier. Referring to the provided example, the search system may query for a vector representing “beach,” and return the location of that vector.

At block 606, once a location is found, the search system defines a search range with boundaries at a threshold distance defined by the distance between vector locations. For example, the distance between vectors is based on a first vector location for a first concept and a distance in n-dimensional space around the first vector location (e.g., referring to FIG. 3, the threshold can be a larger sphere surrounding a particular concept depicted as a sphere such as “desert 308,” with the sphere being the center point of the larger sphere). In some implementations the threshold can be preconfigured (e.g., by an administrator or user) or be automatically determined (e.g., based on the number of results desired, based on the total number of concepts or lodging items in the embedding space, based on processing power of the travel service system 108 server or user device running the query, based on internet speed between travel service system 108 server and the user device running the query, based on a machine learning algorithm, or a combination of factors). Also, for example, it may be desired to present only a certain number of results (e.g., lodging items) to a user running the query, such as 5, 10, 20, etc. results. So, in some implementations, the travel service system 108 can search for (e.g., in the vector database 118) only the number of results desired such as to conserve processing power and/or execute the search more quickly. In some implementations, the travel service system 108 can search for (e.g., in the vector database 118) as many hits (e.g., lodging items) as available (e.g., within a specific distance in the embedding space) and then rank and filter the number of results so that the top 5, 10, 20, etc. results are provided to the user (e.g., via a graphical user interface) for selection by the user.

At block 608, the search system identifies one or more lodging items within the search range defined at block 606. In some implementations, the search system compiles a list of the identified lodging items. In some implementations, the search system identifies other concepts within the search range. In some implementations, the search system then expands the search range to include lodging items within a range of the identified concepts. In some implementations, a search range may not be defined or configured, and the search system may proceed to query all vectors within the embedding space. For example, the search system may query the vector database for lodging items within a range of vector locations. In some implementations, the search system may compile a list of the identified lodging items.

Then, at block 610, the search system generates and transmits an output comprising the one or more lodging items identified at block 608. In some implementations, the search system returns a filtered list of lodging items. For example, in addition to submitting a query of “hotels with beaches” a user may specify that they would like results within a certain price range. The system may extract a list of lodging items close to the concept “beach” and filter this list for lodging items within the price range. The filtered list may then be provided to the user. For instance, if a user queries “hotels with beaches” and specifies a desired price range, the system generates a list of lodging items near the concepts “beach” and filters this list based on the given price range. The type of lodging items may be further limited to hotels. In some implementations, the embedding space can be filtered prior to determining an output of one or more lodging items. For example, instead of filtering a final list of results, the embedding space being searched can be filtered to omit any lodging items that are excluded from the filter. Then, searching the pre-filtered embedding space can be performed. In some implementations, the search system may provide computer-executable display instructions to a user device (e.g., user device(s) 102 of FIG. 1) for display of at least a portion of a list of identified lodging items on a graphical user interface.

### V. Example Computing System

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.) The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

For example, FIG. 7 is a block diagram that illustrates a computer system 700 upon which various embodiments may be implemented. Computer system 700 includes a bus 702 or other communication mechanism for communicating information, and a hardware processor, or multiple processors, 704 coupled with bus 702 for processing information. Hardware processor(s) 704 may be, for example, one or more general purpose microprocessors.

Computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediary information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

Computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 700 may include a user interface module to implement a GUI that may be stored in a mass storage device as computer executable program instructions that are executed by the computing device(s). Computer system 700 may further, as described below, implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more computer readable program instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

Various forms of computer readable storage media may be involved in carrying one or more sequences of one or more computer readable program instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### VI. Additional Implementation Details, Terminology, and Aspects

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

The term “model” or machine learning model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic processes. Similarly, while certain aspects and implementations are discussed herein with reference to use of a ML model, those aspects and implementations may be performed by any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (Large Language Model Meta AI), and BigScience Large Open-science Open-access Multilingual Language Model (BLOOM).

Although the terms machine learning and/or artificial intelligence are used herein, the scope of each term shall include each and every type of machine learning, artificial intelligence, neural network, and the like, known to a person of ordinary skill in the art. An AI or ML model can be built or trained based on sample data or training data in order to make predictions or decisions without being explicitly programmed to do so. In some embodiments, machine learning algorithms, models, and/or programs can perform tasks without being explicitly programmed to do so. For example, some aspects of the present disclosure may include training an AI/ML model in a computer to carry out certain desired tasks that a human may not be able to manually perform.

A number of different types of AI/ML algorithms and AI/ML models or approaches may be used by the machine learning component to implement the models. For example, certain embodiments herein may use a logistical regression model, decision trees, random forests, convolutional neural networks, deep networks, or others. However, other models are possible, such as a linear regression model, a discrete choice model, or a generalized linear model. The machine learning aspects can be configured to adaptively develop and update the models over time based on new input. For example, the models can be trained, retrained, or otherwise updated on a periodic basis as new received data is available to help keep the predictions in the model more accurate as the data is collected over time. Also, for example, the models can be trained, retrained, or otherwise updated based on configurations received from a user, admin, or other devices. Some non-limiting examples of machine learning algorithms that can be used to train, retrain, or otherwise update the models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), support-vector machines, federated learning, and/or other machine learning algorithm. These machine learning algorithms may include any type of machine learning algorithm including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of received data may be analyzed to generate or implement models with minimal, or with no, manual analysis or review by one or more people.

In some embodiments, supervised learning algorithms can build a mathematical model of a set of data that contains both the inputs and the desired outputs. For example, training data can be used, which comprises a set of training or labeled/annotated examples. Each training example has one or more inputs and the desired output, also known as a supervisory signal. In the mathematical model, for example, each training example is represented by an array or vector (e.g., a feature vector), and the training data is represented by a matrix. Through iterative optimization of an objective function, supervised learning algorithms can learn a function that can be used to predict the output associated with new inputs. An optimal function, for example, can allow the algorithm to correctly determine the output for inputs that were not a part of the training data. For instance, an algorithm that improves the accuracy of its outputs or predictions over time is said to have learned to perform that task. Types of supervised-learning algorithms may include, but are not limited to active learning, classification, and regression. Classification algorithms, for example, are used when the outputs are restricted to a limited set of values. Regression algorithms, for example, are used when the outputs may have any numerical value within a range. As an example, for a classification algorithm that filters emails, the input would be an incoming email, and the output would be the name of the folder in which to file the email. In some embodiments, similarity learning, an area of supervised machine learning, is closely related to regression and classification, but the goal is to learn from examples using a similarity function that measures how similar or related two objects are. In some embodiments, similarity learning has applications in ranking, recommendation systems, visual identity tracking, face verification, and speaker verification.

In some embodiments, unsupervised learning algorithms can take a set of data that contains only inputs, and find structure in the data, like grouping or clustering of data points. For example, the algorithms can learn from test data that has not been labeled, classified, or categorized. Instead of responding to feedback, unsupervised learning algorithms can identify commonalities in the data and react based on the presence or absence of such commonalities in each new piece of data. In some embodiments, unsupervised learning encompasses summarizing and explaining data features. In some embodiments, cluster analysis is the assignment of a set of observations into subsets (e.g., clusters) so that observations within the same cluster are similar according to one or more predesignated criteria, while observations drawn from different clusters are dissimilar. In some cases, different clustering techniques can make different assumptions on the structure of the data, often defined by some similarity metric and evaluated, for example, by internal compactness, or the similarity between members of the same cluster, and separation, the difference between clusters. Other methods, for example, can be based on estimated density and graph connectivity.

In some embodiments, semi-supervised learning can be a combination of unsupervised learning (without any labeled training data) and supervised learning (with completely labeled training data). For example, some of the training examples may be missing training labels, and in some cases such training examples can produce a considerable improvement in learning accuracy as compared to supervised learning. In some embodiments, and in weakly supervised learning, the training labels can be noisy, limited, or imprecise; however, these labels are often cheaper to obtain, resulting in larger effective training sets.

In some embodiments, an area of machine learning is concerned with how software agents ought to take actions in an environment so as to maximize some notion of cumulative reward. In some embodiments, the environment is typically represented as a Markov decision process (MDP). In some embodiments, reinforcement learning algorithms use dynamic programming techniques. In some embodiments, reinforcement learning algorithms do not assume knowledge of an exact mathematical model of the MDP and are used when exact models are infeasible.

In addition to supervised learning algorithms, unsupervised learning algorithms, and semi-supervised learning, and in some embodiments, other types of machine learning methods can be implemented, such as: reinforcement learning (e.g., how software agents ought to take actions in an environment so as to maximize some notion of cumulative reward); dimensionality reduction (e.g., process of reducing the number of random variables under consideration by obtaining a set of principal variables); self-learning (e.g., learning with no external rewards and no external teacher advice); feature learning or representation learning (e.g., preserve information in their input but also transform it in a way that makes it useful); anomaly detection or outlier detection (e.g., identification of rare items, events or observations which raise suspicions by differing significantly from the majority of the data); association rules (e.g., discovering relationships between variables in large databases); and/or the like.

Additionally, depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Further, according to various embodiments, various interactive graphical user interfaces can be provided for allowing various types of users to interact with the systems and methods described herein to, for example, generate, review, and/or modify data captured by or used by one or more of the disclosed systems or methods.

The interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Accordingly, in various embodiments, large amounts of data may be automatically and dynamically gathered and analyzed in response to user inputs and configurations, and the analyzed data may be efficiently presented to users. Thus, in some embodiments, the systems, devices, configuration capabilities, graphical user interfaces, and the like described herein are more efficient as compared to previous systems, and/or the like.

Various embodiments of the present disclosure provide improvements to various technologies and technological fields, and practical applications of various technological features and advancements. For example, as described above, some existing systems are limited in various ways, and various embodiments of the present disclosure provide significant improvements over such systems, and practical applications of such improvements. Additionally, various embodiments of the present disclosure are inextricably tied to, and provide practical applications of, computer technology. In particular, various embodiments rely on specialized hardware installed in specific locations as well as software components to improve energy and processing efficiency. Such features and others are intimately tied to, and enabled by, computer technology, artificial intelligence, and digital signal technology and would not exist except for computer technology, artificial intelligence, and digital signal technology. For example, the review analysis system, embedding system, and search system cannot reasonably be performed by humans alone, without the computer and technology upon which they are implemented. Further, the implementation of the various embodiments of the present disclosure via computer technology enables many of the advantages described herein, including more efficient interaction with, and analysis of, various types of electronic data, and the like.

Various combinations of the above recited features, embodiments, and aspects are also disclosed and contemplated by the present disclosure. Additional embodiments of the disclosure are described below in reference to the appended claims, which may serve as an additional summary of the disclosure.

In various embodiments, systems and/or computer systems are disclosed that comprise a computer-readable storage medium having program instructions embodied therewith, and one or more processors configured to execute the program instructions to cause the systems and/or computer systems to perform operations comprising one or more aspects of the above- and/or below-described embodiments (including one or more aspects of the appended claims).

In various embodiments, computer-implemented methods are disclosed in which, by one or more processors executing program instructions, one or more aspects of the above- and/or below-described embodiments (including one or more aspects of the appended claims) are implemented and/or performed.

In various embodiments, computer program products comprising a computer-readable storage medium are disclosed, wherein the computer-readable storage medium has program instructions embodied therewith, the program instructions executable by one or more processors to cause the one or more processors to perform operations comprising one or more aspects of the above- and/or below-described embodiments (including one or more aspects of the appended claims).

Although certain preferred embodiments and examples are disclosed above, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A computer-implemented method comprising:
as implemented by a computing system comprising one or more processors configured to execute specific instructions:
accessing review data, wherein the review data comprises a plurality of reviews, each review corresponding to at least one lodging item of a plurality of lodging items, including at least one concept among a plurality of concepts, and indicating at least one sentiment associated with the at least one concept;
identifying, from the review data, a set of associations, wherein each association of the set of associations indicates that each review of the plurality of reviews: corresponds to a particular lodging item from the plurality of lodging items, includes a particular concept from the plurality of concepts, and indicates a particular sentiment;
generating a set of embeddings for each of the plurality of lodging items and each of the plurality of concepts, the set of embeddings locating each lodging item and each concept within a shared multi-dimensional embedding space, wherein generating the set of embeddings comprises, for each of the set of associations, modifying a distance between the particular lodging item of the association and the particular concept included in the association based at least in part on the particular sentiment of the association; and
storing the set of embeddings.

2. The computer-implemented method of claim 1, further comprising:
receiving a query comprising a search string, wherein the search string includes at least a first concept;
identifying a first concept embedding representing the first concept from the set of embeddings;
calculating distances between the first concept embedding and lodging item embeddings within the set of embeddings;
based on the calculated distances, determining a set of lodging item embeddings corresponding to a set of lodging items; and
outputting the set of lodging items in response to the query received.

3. The computer-implemented method of claim 2, further comprising:
prior to outputting the set of the lodging items, performing a filter operation on the set of lodging items based on at least one of a price filter and an availability filter.

4. The computer-implemented method of claim 2, further comprising:
identifying a second concept embedding within a threshold distance to the first concept within the set of embeddings;
determine a second set of lodging items that meet similarity criteria with respect to the first concept embedding and the second concept embedding; and
outputting the second set of lodging items in response to the query received.

5. The computer-implemented method of claim 1, wherein modifying the distance between the particular lodging item and the particular concept comprises:
based on a determination that a first sentiment of a first association of the set of associations is positive, modifying a first distance between a first lodging item and a first concept so that the first distance is reduced; or
based on a determination that the first sentiment of the first association is negative, modifying the first distance so that the first distance is increased.

6. The computer-implemented method of claim 1, wherein modifying the distance between the particular lodging item and the particular concept comprises, and based on application of a triplet loss function:
based on a determination that a first sentiment of a first association of the set of associations is positive based on a first lodging item as an anchor, modifying a first distance between a first lodging item and a first concept so that the first distance is reduced; or
based on a determination that the first sentiment of the first association is negative based on a first lodging item as an anchor, modifying the first distance so that the first distance is increased.

7. The computer-implemented method of claim 1, wherein modifying the distance between the particular lodging item and the particular concept comprises:
calculating the loss function L=max{0, m−ƒ(h, c⁺)+ƒ(h, c⁻)}, where ƒ(h, c) is a similarity function, m is a margin, h is a lodging item, c is a concept so that c⁺ is a positive concept and c⁻ is a negative concept; and
modifying the first distance based on the calculation of the loss function.

8. The computer-implemented method of claim 1, wherein the computer-implemented method is further implemented as a two-tower architecture, wherein a first tower is based on the plurality of concepts and a second tower is based on the plurality of lodging items.

9. The computer-implemented method of claim 1, wherein the identified concepts comprise one or more of the following: weather, nearby landmarks, landmark characteristics, season, pricing, and activities.

10. The computer-implemented method claim 1, wherein the generating the set of embeddings is performed by using a learning function or a machine learning model.

11. The computer-implemented method of claim 1, wherein the one or more processors are further configured to select a dimensionality for the embedding space.

12. The computer-implemented method claim 3, wherein the selection is based at least in part on statistics of the review data by using a learning function or a machine learning model.

13. The computer-implemented method claim 1, further comprising:
accessing updated review data, based at least in part on an occurrence of a review event comprising an end of a set interval for updating one or more embeddings of the set of embeddings;
iteratively processing each mention of each concept in the updated review data, wherein, for a first review of the updated review data, the iteratively processing includes:
calculate a first distance between a first concept embedding and a first lodging item embedding;
perform a first determination that the first distance does not accurately represent a relationship between the first concept embedding and a first lodging item embedding; and
based on the first determination, update the first concept embedding, the first lodging item embedding, or both.

14. The computer-implemented method of claim 1, wherein identifying a concept in the review data is based at least in part on a frequency of appearance of a term within the review data.

15. The computer-implemented method of claim 1, wherein identifying sentiments within the review data is based, at least in part, on identifying features within each review of the plurality of reviews.

16. A system comprising:
a computer-readable storage medium storing program instructions; and
one or more processors configured to execute the program instructions to cause the system to:
access review data, wherein the review data comprises a plurality of reviews, each review corresponding to at least one lodging item of a plurality of lodging items, including at least one concept among a plurality of concepts, and indicating at least one sentiment associated with the at least one concept;
identify, from the review data, a set of associations, wherein each association of the set of associations indicates that each review of the plurality of reviews: corresponds to a particular lodging item from the plurality of lodging items, includes a particular concept from the plurality of concepts, and indicates a particular sentiment;
generate a set of embeddings for each of the plurality of lodging items and each of the plurality of concepts, the set of embeddings locating each lodging item and each concept within a shared multi-dimensional embedding space, wherein generating the set of embeddings comprises, for each of the set of associations, modifying a distance between the particular lodging item of the association and the particular concept included in the association based at least in part on the particular sentiment of the association; and
store the set of embeddings.

17. The system of claim 16, wherein the one or more processors are configured to:
receive a query comprising a search string, wherein the search string includes at least a first concept;
identify a first concept embedding representing the first concept from the set of embeddings;
calculate distances between the first concept embedding and lodging item embeddings within the set of embeddings;
based on the calculated distances, determine a set of lodging item embeddings corresponding to a set of lodging items; and
output the set of lodging items in response to the query received.

18. The system of claim 16, wherein modifying the distance between the particular lodging item and the particular concept comprises:
based on a determination that a first sentiment of a first association of the set of associations is positive, modifying a first distance between a first lodging item and a first concept so that the first distance is reduced; or
based on a determination that the first sentiment of the first association is negative, modifying the first distance so that the first distance is increased.

19. The system of claim 16, wherein modifying the distance between the particular lodging item and the particular concept comprises:
calculating the loss function L=max{0, m−ƒ(h, c⁺)+ƒ(h, c⁻)}, where ƒ(h, c) is a similarity function, m is a margin, h is a lodging item, c is a concept so that c⁺ is a positive concept and c⁻ is a negative concept; and
modifying the first distance based on the calculation of the loss function.

20. The system of claim 16, wherein the one or more processors are configured to:
access updated review data, based at least in part on an occurrence of a review event comprising an end of a set interval for updating one or more embeddings of the set of embeddings;
iteratively process each mention of each concept in the updated review data, wherein, for a first review of the updated review data, the iteratively processing includes:
calculate a first distance between a first concept embedding and a first lodging item embedding;
perform a first determination that the first distance does not accurately represent a relationship between the first concept embedding and a first lodging item embedding; and
based on the first determination, update the first concept embedding, the first lodging item embedding, or both.
